(19) United States
(12) Patent Application Publication
(10) Pub. No.: US 2017/0037346 A1
(43) Pub. Date: Feb. 9, 2017

(54) METHOD FOR EXTRACTION AND DISSOLUTION OF HOP ACIDS IN AQUEOUS MEDIA

(71) Applicant: IFAST NV, Roosdaal (BE)

(72) Inventor: Pascal MERTENS, Roosdaal (BE)

(21) Appl. No.: 15/118,158

(22) PCT Filed: Feb. 12, 2015
(86) PCT No.: PCT/EP15/52990

§ 371 Date: Aug. 11, 2016

(30) Foreign Application Priority Data
Feb. 12, 2014 (GB) 1402471.5

(51) Int. Cl. C12C 3/08; C12C 3/12; C12C 11/11; C12C 7/20

(52) U.S. Cl. CPC C12C 3/08; C12C 7/205; C12C 3/12; C12C 11/11

(57) ABSTRACT

The present invention relates to a method for extraction and dissolution of hop acids, including alpha-acids, iso-alpha-acids, beta-acids and derivatives thereof, in aqueous media, comprising the formation of quaternary ammonium salts of hop acids with quaternary ammonium compounds or mixtures thereof; The invention further relates to, the use of quaternary ammonium salts of hop acids in the beer brewing process. The present invention further relates to a method for preparing a brewed beverage, particularly for brewing a beer, and in particular to a method to improve the utilization of hop acids, including alpha-acids and (reduced) iso-alpha-acids in the brewing process.

### FIELD OF THE INVENTION

The present invention relates to a method for extraction and dissolution of hop acids, including alpha-acids (and derivatives), iso-alpha-acids (and derivatives, such as reduced iso-alpha-acids) and beta-acids (and derivatives), in aqueous media, comprising the formation of quaternary ammonium salts of hop acids with quaternary ammonium compounds (or mixtures thereof).

The present invention further relates to a method for preparing a brewed beverage, particularly for brewing a beer, and in particular to a method to improve the utilization of hop acids, including alpha-acids and (reduced) iso-alpha-acids, in the brewing process.

### BACKGROUND OF THE INVENTION

Hop acids like alpha-acids (with as principal analogues humulone, cohumulone and adhumulone), iso-alpha-acids (cis- and trans-isomers of isohumulone, isocohumulone and isoadhumulone as the principal analogues), beta-acids (predominantly lupulone, colupulone and adlupulone), and derivatives of the aforementioned hop acids (for example reduced and oxidized derivatives), being weak organic acids with usually a molecular weight above 300 g/mol, have a rather low solubility and thus do not readily dissolve in aqueous media, especially in acidic aqueous media such as wort and beer (Spetsig, Acta Chemica Scandinavica 9 (1955) 1421). During the wort boiling stage (typical pH 5-5.5) of the brewing process, the alpha-acid solubility is about 200 mg/L and 10 mg/L for the beta-acids. Under finished beer storage conditions (pH 4-4.5 and 278 K), the solubility of alpha-acids is around 5 mg/L and <1 mg/L for the beta-acids, while the iso-alpha-acids (the isomerized and distinctly more bitter derivatives of the alpha-acids) have a solubility of at most 120 mg/L under those conditions (Briggs et al., Brewing Science and Application (2004) 287, Woodhead Publishing Limited Cambridge England).

These low solubilities and the variations in solubility in (acidic) aqueous media, with beta-acids (pKa around 6) having the lowest solubility, alpha-acids (pKa around 5) higher, and the iso-alpha-acids (pKa around 4) the highest, are directly linked to their pKa values. This implies that upon adding iso-alpha-acids, and especially alpha-acids and beta-acids, to acidic aqueous media at a pH of about 5 (wort boiling) or about 4 (post-fermentation), only a fraction of the added hop acids will actually readily dissolve in these acidic aqueous media.

This low hop acid solubility in acidic aqueous media is disadvantageous for their brewing application (Meilgaard et al., Proceedings of the European Brewery Convention (1955) 109). As a consequence of the low alpha-acid solubility, only a fraction (usually 50-55%) of the added alpha-acids (e.g. added as hop pellets or as a hop extract, produced by CO2 extraction starting from hop pellets) is extracted into and dissolves in the boiling wort medium, and it is only this dissolved alpha-acid fraction that readily isomerizes to the bitter iso-alpha-acids (Briggs et al., Brewing Science and Application (2004) 287, Woodhead Publishing Limited Cambridge England). An increase in the fraction of alpha-acids extracted into and dissolved in the aqueous wort medium would thus be benefical for the alpha-acid bittering utilization (the percentage of bitter iso-alpha-acids in the final beer versus the quantity of alpha-acids added during the brewing process, typically to the (boiling) wort), which is typically only 30-35% for brew kettle additions (e.g. at 50 ppm alpha-acid addition levels). In the case of iso-alpha-acids in the free acid form (such as in the commercially available isomerized kettle extracts (IKE), containing i.α. iso-alpha-acids and beta-acids in the free acid form) added to the (boiling) wort (in the brew kettle), typically iso-alpha-acid utilizations (the percentage of bitter iso-alpha-acids in the final beer versus the quantity of iso-alpha-acids added during the brewing process, usually to the (boiling) wort) below 50% (e.g. at 40 ppm iso-alpha-acid addition levels) are obtained, as a result of the incomplete extraction and dissolution of the iso-alpha-acids from the IKE phase into the aqueous wort medium (pH 5-5.5). For reduced derivatives of iso-alpha-acids (such as tetrahydro-iso-alpha-acids, characterized by an even higher hydrophobicity than iso-alpha-acids) in the free acid form, even lower utilizations are usually obtained for additions to (boiling) wort.

To increase the efficiency of extraction and dissolution of hop acids in (acidic) aqueous media, multiple methods involving the transformation of hop acids to specific salt and complex derivatives have been proposed. The primary focus of these methods was to increase the addition efficiency of iso-alpha-acids for post-fermentation bittering additions.

Koller informed on alkaline earth metal (e.g. Mg) salts of the iso-alpha-acids (for example in the form of finely ground particles) as beer bittering agents (Koller, Journal of the Institute of Brewing 75 (1969) 175). U.S. Pat. No. 5,015,491 (1988) describes the solvent-free formation of Mg iso-alpha-acid salts (Mg isohumulates) in a hop extract, by transformation of the present alpha-acids to the corresponding Mg salts (Mg humulates) and under the effect of thermal isomerization. Such Mg salts of iso-alpha-acids can also be found in isomerized hop pellets (hop pellets in which a large fraction (typically >90%) of the alpha-acids is converted into iso-alpha-acids). Addition of magnesium isohumulates to the (boiling) wort (in the brew kettle) usually results in iso-alpha-acid utilizations of 40-45%, comparable to, or slightly lower than the utilizations obtained with iso-alpha-acids in the free acid form.

U.S. Pat. No. 3,532,504 (1970) and U.S. Pat. No. 3,949,092 (1976) report on the use of alkali metal salts (e.g. K salts) of iso-alpha-acids as bittering agents, resulting in increased iso-alpha-acid dissolution efficiencies and thus higher iso-alpha-acid utilizations in comparison with iso-alpha-acids in the free acid form. U.S. Pat. No. 5,015,491 (1991) also mentions the production of such alkali metal isohumulates. In the brewing practice, these alkali metal isohumulates (as in PIKE, an isomerized kettle extract mixed with a potassium compound) lead to iso-alpha-acid utilizations of 50-60% for additions to the (boiling) wort.

Hudson and Rudin alternatively introduced ammonia iso-alpha-acid complexes, using ammonia in a methanolic iso-alpha-acid solution (Hudson and Rudin, Journal of the Institute of Brewing 65 (1959) 416). U.S. Pat. No. 3,636,495 (1970) shows the preparation of granular ammonia iso-alpha-acid complexes in an anhydrous solvent. This preparation method involves the use of toxic and corrosive ammonia gas and hydrocarbon solvents. The iso-alpha-acid utilization obtained with these ammonia iso-alpha-acid complexes was below 40% for an addition to (boiling) wort.

Thus, the prior art proposes three methods to increase the extraction and dissolution efficiency for hop acids upon addition to (acidic) aqueous media, such as the (boiling) wort or the brewed beverage stream, during the brewing process. These methods involve the formation of alkaline earth metal hop acid salts, formation of alkali metal hop acid salts or formation of ammonia hop acid complexes. Only the alkali metal hop acid salts markedly improve the extraction and dissolution efficiency in an (acidic) aqueous medium compared to the corresponding hop acids in the free acid form, but still relatively low hop acid utilizations are obtained. There thus remains a need for an improved method for extraction and dissolution of hop acids in (acidic) aqueous media, in particular a need for a method to improve the utilization of hop acids in the brewing process.

### DESCRIPTION OF THE INVENTION

The inventors have found that the utilization of hop acids, e.g. alpha-acids and (reduced) iso-alpha-acids, in the brewing process is improved by adding quaternary ammonium salts of these hop acids during the brewing process, instead of adding these hop acids in the free acid form or as magnesium or potassium salts.

The invention relates to a method for preparing a brewed beverage, in particular for brewing a beer, comprising the addition of one type or more than one type of quaternary ammonium salts of hop acids during the brewing process.

The invention further relates to a method for preparing a brewed beverage, comprising the formation of one type or more than one type of quaternary ammonium salts of hop acids, and the addition of the quaternary ammonium salts of hop acids during the brewing process.

The invention further relates to a method for the formation of one type or more than one type of quaternary ammonium salts of hop acids, comprising contacting (blending or mixing) a hop acids containing matter with one or more quaternary ammonium compounds, thereby forming quaternary ammonium salts of hop acids, with a higher solubility in (acidic) aqueous media compared to the corresponding hop acids in the free acid form, and with at least a 0.1 weight % content of hop acids in the (aqueous) medium, mixture or blend wherein the formation of the quaternary ammonium salts of the hop acids occurs.

The invention further relates to a method for extraction of one type or more than one type of hop acids into an aqueous medium from a hop acids containing matter and for dissolution of one type or more than one type of hop acids extracted from said hop acids containing matter in an (acidic) aqueous medium, comprising contacting (blending or mixing) a hop acids containing matter with one or more quaternary ammonium compounds, thereby forming quaternary ammonium salts of hop acids, with a higher solubility in (acidic) aqueous media compared to the corresponding hop acids in the free acid form, and with at least a 0.1 weight % content of hop acids in the (aqueous) medium, mixture or blend wherein the formation of the quaternary ammonium salts of the hop acids occurs.

The invention further relates to a method for preparing a modified hop acids containing matter (suitable for addition during the brewing process), comprising formation of one type or more than one type of quaternary ammonium salts of hop acids. Thus the hop acids containing matter is modified by the formation of one type or more than one type of quaternary ammonium salts of hop acids.

The invention further relates to a method for preparing a modified hop acids containing matter (suitable for addition during the brewing process), comprising contacting (blending or mixing) a hop acids containing matter with one or more quaternary ammonium compounds, thereby forming quaternary ammonium salts of hop acids, with a higher solubility in (acidic) aqueous media compared to the corresponding hop acids in the free acid form, and with at least a 0.1 weight % content of hop acids in the (aqueous) medium, mixture or blend wherein the formation of the quaternary ammonium salts of the hop acids occurs.

The invention further relates to hop acids containing matter containing one type or more than one type of quaternary ammonium salts of hop acids.

The invention further relates to the use of quaternary ammonium salts of hop acids in the brewing process.

The invention further relates to the use of a hop acids containing matter, in which at least a fraction of the hop acids (one type or more than one type) is present as quaternary ammonium salts, as a bittering agent, in particular as a bittering agent for beer.

The hop acids, the quaternary ammonium compounds, respectively the quaternary ammonium salts of hop acids may all be of one type or they may be of more than one type, i.e. at least two types of hop acids, at least two types of quaternary ammonium compounds, or at least two types of quaternary ammonium salts of hop acids may be present in a product of the invention, or used or formed in a method of the invention. For the quaternary ammonium salts of hop acids, one type means a salt of one type of hop acids with one type of quaternary ammonium compounds. More than one type means that there are salts differing from each other in that they contain a different type of hop acids and/or a different type of quaternary ammonium compounds.

The invention further relates to a brewed beverage, in particular a beer, obtainable by a method of the invention.

For the purpose of clarity and a concise description, features are described herein as part of the same or separate embodiments, however, it will be appreciated that the scope of the invention may include embodiments having combinations or all or some of the features below.

The term quaternary ammonium compounds should be understood in the meaning of carbon-containing chemical substances in which there is a nitrogen atom, with a (permanent) positive charge, that with respect to covalent bonding has only covalent nitrogen carbon bonds and no covalent nitrogen hydrogen bonds. Electroneutrality of the quaternary ammonium compounds is typically brought about by a counter anion (e.g. hydroxide, bicarbonate or a carboxylate) or a negatively charged organic group forming part of the quaternary ammonium compound (such as a dissociated carboxyl group).

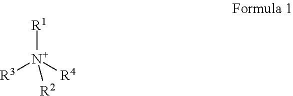

The quaternary ammonium compounds are generally represented by Formula 1. Herein, R¹, R², R³ and R⁴ each represent an organic group, which may be the same or different. The organic group has generally one to twenty carbon atoms, in particular one to eight carbon atoms. Typically, the R groups are selected from the group of alkyls, substituted alkyls, alkenyls, substituted alkenyls, alkynyls, substituted alkynyls, cyclo-alkyls, substituted cyclo-alkyls, aryls and substituted aryls. Optionally, two or more of these organic groups may be connected, thereby forming ring structures. The R groups may also contain saturated and unsaturated carbon hetero atom bonds. The R groups may have one or more substituents, e.g. a hydroxyl functional group, an ether functional group, a carbonyl functional group, a carboxyl functional group, an ester functional group, or a halo functional group.

Other quaternary ammonium compounds are for example N-alkyl pyridinium compounds and other N-carbon substituted pyridinium compounds.

The term hop acids is used herein in particular for alpha-acids, alpha-acid derivatives such as reduced alpha-acids, iso-alpha-acids, iso-alpha-acid derivatives such as reduced iso-alpha-acids, beta-acids and beta-acid derivatives such as reduced or oxidized beta-acids. The hop acids are generally selected from one or more of the following types: alpha-acids, beta-acids, iso-alpha-acids, reduced alpha-acids, reduced beta-acids, reduced iso-alpha-acids, oxidized alpha-acids, oxidized beta-acids and oxidized iso-alpha-acids. In particular, the hop acids are selected from one or more of the following types: alpha-acids, beta-acids, iso-alpha-acids and reduced iso-alpha-acids. Thus, one type of hop acids can be for example only alpha-acids, or only beta-acids, or only iso-alpha-acids, or only reduced iso-alpha-acids, or even only one analogue of for example alpha-acids (humulone) or iso-alpha-acids (isohumulone), etc. More than one type of hop acids can be any combination of hop acids, for example alpha-acids and beta-acids, or iso-alpha-acids and beta-acids, or alpha-acids, beta-acids and iso-alpha-acids, or iso-alpha-acids and reduced iso-alpha-acids, etc.

We found that the quaternary ammonium salts of hop acids more readily dissolve in (acidic) aqueous media compared to the analogues in the free acid form, which is reflected in higher hop acid utilizations for additions to (acidic) aqueous media of hop acids converted to the corresponding quaternary ammonium salts. We first observed this increased solubility and utilization in a lager beer brewing trial series studying additions to (boiling) wort. We found an iso-alpha-acid utilization above 75% in the case of a 50 ppm iso-alpha-acid addition applying an isomerized kettle extract in which the iso-alpha-acids were converted to choline iso-alpha-acid salts (or choline isohumulate salts). In the control brewing trial, using a regular isomerized kettle extract containing iso-alpha-acids in the free acid form, the typical iso-alpha-acid utilization of <50% was observed. This enhanced iso-alpha-acid utilization for the choline iso-alpha-acid salts was unexpected in view of the earlier reported iso-alpha-acid utilizations below 40% for brew kettle additions obtained with ammonia iso-alpha-acid complexes (U.S. Pat. No. 3,636,495 (1970)).

This improved dissolution and utilization of hop acids transformed into to the corresponding quaternary ammonium salts was also found in multiple subsequent experimental hop acid additions to aqueous media applying variations in quaternary ammonium compound, hop acid (for example alpha-acids, beta-acids, etc.), application mode, hop acid addition level, pH value and temperature of the aqueous medium (boiling wort versus stored final beer). These experimental data demonstrated that this improved dissolution and utilization was not limited to the choline iso-alpha-acid salts (or choline isohumulate salts), and showed the increased dissolution and utilization of a.o. other quaternary ammonium salts of iso-alpha-acids, the quaternary ammonium salts of alpha-acids (quaternary ammonium humulate salts) and the quaternary ammonium salts of beta-acids (quaternary ammonium lupulate salts).

The method according to the present invention comprises contacting, blending or mixing hop acids containing matter with quaternary ammonium compounds (or mixtures thereof), in the absence or presence of solvents, to obtain the quaternary ammonium salts of hop acids, which show markedly higher solubility in (acidic) aqueous media compared to the hop acid analogues in the free acid form.

In particular, there are two application modes for the present invention, with the formation of the quaternary ammonium salts of hop acids either ex-situ or in-situ. The ex-situ formation, which can be performed on the brewery site or outside of the brewery site, of the quaternary ammonium salts of the hop acids (in the absence or presence of solvents) involves the formation of the quaternary ammonium salts of the hop acids, optionally with further processing, prior to their addition to an or another (more acidic) aqueous medium. In the second application mode, which can be performed on the brewery site or outside of the brewery site, i.e. the mode wherein in-situ formation of the quaternary ammonium salts of the hop acids in an aqueous medium takes place, the hop acids are extracted into the aqueous medium from the hop acids containing matter and dissolved in the aqueous medium upon addition of quaternary ammonium compounds (or mixtures thereof) to the aqueous medium. Then, the obtained aqueous phase containing quaternary ammonium salts of hop acids can be added, optionally after further processing, to another (more acidic) aqueous medium.

The addition of the quaternary ammonium salts of hop acids can be at any stage of the brewing process, but will usually be prior to the final filtration, and typically to the (boiling) wort or to the brewed beverage stream post-fermentation. The addition of quaternary ammonium salts of (reduced or oxidized) alpha-acids and (reduced or oxidized) beta-acids will usually be to the wort. The addition of quaternary ammonium salts of (reduced or oxidized) iso-alpha-acids will usually be to the wort, but these quaternary ammonium salts of (reduced or oxidized) iso-alpha-acids are also particularly suitable for addition to the brewed beverage stream post-fermentation.

The formation of the quaternary ammonium salts of alpha-acids (optionally reduced) starting from an alpha-acids containing matter can be combined with the (partial) isomerization of these alpha-acids, as the formed quaternary ammonium salts consist of quaternary ammonium cations and humulate anions (the conjugate bases of the alpha-acids), and the latter readily isomerize (under the effect of thermal isomerization) to isohumulate anions (the conjugate bases of iso-alpha-acids). This combination of formation of quaternary ammonium salts of alpha-acids and isomerization to quaternary ammonium salts of iso-alpha-acids (or quaternary ammonium isohumulate salts), which will further improve the alpha-acid utilization in brewing, can be achieved in both the ex-situ and the in-situ application mode of the present invention, by applying modified contacting, blending or mixing conditions characterized by longer processing times and higher processing temperatures.

Examples of quaternary ammonium compounds are chemical substances of the alcohol quaternary ammonium type, the carboxyl quaternary ammonium type, the ester quaternary ammonium type, the alkyl quaternary ammonium type, the aryl quaternary ammonium type, the N-alkyl pyridinium type, etc., and their (functionalized) derivatives. Examples of quaternary ammonium compounds of the alcohol quaternary ammonium type are choline hydroxide and choline bicarbonate. Examples for the carboxyl quaternary ammonium type are betaine and salts thereof, such as betaine citrate. It is understood that this list is not limitative, and also other quaternary ammonium compounds can be used within the present invention.

In a preferred embodiment of the present invention, at least one, at least two, or at least three of the R groups of the quaternary ammonium compound have one, two or three carbon atoms.

In a preferred embodiment of the present invention, at least one, at least two, or at least three of the R groups of the quaternary ammonium compound are methyl or ethyl groups.

In a preferred embodiment of the present invention, at least one R group of the quaternary ammonium compound is a hydroxy-alkyl or a carboxy-alkyl group.

In a preferred embodiment of the present invention, quaternary ammonium compounds that are safe, that have GRAS status for food and beverage applications, that are food additives, that are processing aids used in food and beverage industries, that are natural, that are naturally occurring (in the human body), or that are essential nutrients are used.

The hop acids containing matter can be hop cones, raw hops, dried hops, baled hops, powdered hops, powdered hops containing iso-alpha-acids, hop pellets, hop pellets containing iso-alpha-acids, hop extracts, hop extracts containing alpha-acids and beta-acids, hop extracts containing apart from the alpha-acids and beta-acids also hop oils and/or hop hard resins, purified alpha-acid extracts, alpha-acid concentrates, hop base extracts, purified beta-acid extracts, beta-acid concentrates, hop extracts containing iso-alpha-acids, isomerized hop extracts, hop extracts enriched in iso-alpha-acids, purified iso-alpha-acid extracts, iso-alpha-acid concentrates, hop extracts enriched in reduced hop acids, purified reduced hop acid extracts and reduced hop acid concentrates. It is understood that this list of types of hop acids containing matter is not limitative, and also other types of hop acids containing matter can be used within the present invention.

The quaternary ammonium salts of the hop acids can be formed, in the absence of solvents (solvent-free conditions), by blending or mixing the quaternary ammonium compounds (or mixtures thereof) with e.g. milled or powdered hops containing alpha-acids (eventually prior to pelletizing the blend material), or hop extracts containing alpha-acids, or pre-isomerized hop extracts containing iso-alpha-acids. These quaternary ammonium salts of hop acids can also be formed in the presence of (organic) solvents or mixtures of solvents, such as water and ethanol. Adding ethanol can for example facilitate the salt formation by lowering the viscosity of a hop extract and thus improving the mixing of the hop acids with the quaternary ammonium compounds. Alternatively, adding water can for example be beneficial in the case of water-soluble quaternary ammonium compounds.

The formation of the quaternary ammonium salts of the hop acids can be positively affected by an increase in processing temperature (as a result of improved salt formation kinetics and lower viscosity, as in the case of viscous hop acid extracts); however too high temperatures could cause undesired degradation of thermally instable hop substances (especially the hop oils) present in the hop acids containing matter. Preferably, the processing temperature is at least 278 K, more preferably at least 293 K. Processing temperatures below 383 K are preferred, processing temperatures below 368 K are more preferred.

Preferably, the contacting of the hop acids containing matter with the quaternary ammonium compounds (or mixtures thereof), to obtain the quaternary ammonium salts of the hop acids, occurs under an oxygen-free atmosphere or in low oxygen conditions to avoid oxidative degradation of the hop acids and/or other hop substances such as hop oils that also may be present, as these hop compounds are particularly susceptible to oxidative degradation. Such inert atmospheres can be created using gases like nitrogen or noble gases.

Another variable affecting the quaternary ammonium salt formation is the molar ratio of quaternary ammonium compound versus hop acid. The molar ratio of quaternary ammonium compounds to hop acids is usually at least 1:10, in particular at least 1:5, more in particular at least 1:2, preferably at least about 1:1. Usually, this molar ratio of quaternary ammonium compounds to hop acids is 20:1 or less, in particular 10:1 or less, more in particular 5:1 or less, preferably 2:1 or less. To achieve a high fraction—preferably at least 50%, more preferably at least 70%, most preferably at least 90%—of hop acids transformed into quaternary ammonium salts, or particularly a (nearly) complete conversion of the present hop acids to quaternary ammonium salts, at least the same molar amount of quaternary ammonium compounds as the molar amount of present hop acids is preferred. An excess (or a higher relative concentration) of the quaternary ammonium compounds, and thus a molar ratio versus hop acids higher than 1:1, is useful to ensure that a large fraction of the present hop acids are converted to quaternary ammonium salts within reasonable time (as a result of the higher salt formation rate).

Higher fractional contents or concentrations of hop acids and quaternary ammonium compounds in the quaternary ammonium salt formation medium also allow shorter processing times as the incidence of contact (followed by quaternary ammonium salt formation) between the hop acid and the quaternary ammonium compound is higher. For this reason, the hop acid content in the (aqueous) medium, mixture or blend wherein the formation of the quaternary ammonium salts of the hop acids occurs is 0.1 weight % or higher. At lower hop acid contents or concentrations, the incidence of contact (and thus the quaternary ammonium salt formation) between the hop acids and the quaternary ammonium compounds can be too low and thus very long processing times would be required. Hop acid contents, in the (aqueous) medium, mixture or blend wherein the quaternary ammonium salt formation occurs, of >0.5 weight % are more preferred, and of >1.0 weight % are most preferred. In principle, there is no critical upper limit to the hop acid content. In principle, the hop acids containing matter may essentially consist of hop acids, e.g. a hop acid content higher than 90% is feasible. In practice, one may decide to operate at lower hop acid contents, e.g. of 80 weight % or less, of 70 weight % or less, e.g. in the range of 10-60 weight %.

Preferably, the contacting of the hop acids containing matter with the quaternary ammonium compounds (or mixtures thereof), to obtain the quaternary ammonium salts of the hop acids, is allowed to proceed under conditions suitable to obtain a high fraction of the present hop acids converted to quaternary ammonium salts. Applying optimized processing conditions, a >70% fraction of quaternary ammonium salts of hop acids or even a >90% fraction of converted hop acids can be achieved with processing times as short as 30 min, at least for some embodiments of the present invention.

The details of the invention will be explained below with reference to the Examples.

In a preferred embodiment of the present invention, the hop acids containing matter is a regular hop extract (containing i.α. alpha-acids and beta-acids), an extract enriched in alpha-acids (or a purified alpha-acid extract) or an extract enriched in beta-acids (or a purified beta-acid extract). The hop acids are, in the ex-situ application mode, (partially) transformed to the corresponding quaternary ammonium salts upon mixing with quaternary ammonium compounds (or mixtures thereof) prior to their addition to the (acidic) aqueous medium. Optionally, the addition of the quaternary ammonium salts of the hop acids to the (acidic) aqueous medium (e.g. the wort medium in the brew kettle) may be preceded by an addition to another (less acidic) aqueous medium. This embodiment is especially useful to achieve higher utilizations of alpha-acids in the case of additions to (boiling) wort of hop extracts. This embodiment is also useful to produce aqueous solutions of alpha-acids and aqueous solutions of beta-acids, with water addition after the quaternary ammonium salt formation.

In a preferred embodiment of the present invention, the modified hop extract, in which the present hop acids have been (partially) transformed into the corresponding quaternary ammonium salts by mixing the hop extract with quaternary ammonium compounds, is added to an (acidic) aqueous medium.

In a preferred embodiment of the present invention, the hop acids containing matter are milled hops, powdered hops or hop pellets (containing a.o. alpha-acids and beta-acids). The hop acids in the milled hops, powdered hops or hop pellets are, in the ex-situ application mode, (partially) transformed into quaternary ammonium salts upon blending with quaternary ammonium compounds (or a mixture thereof), prior to their addition to the (acidic) aqueous medium. Optionally, the addition of the quaternary ammonium salts of the hop acids to the (acidic) aqueous medium (e.g. the wort medium) may be preceded by an addition to another (less acidic) aqueous medium. This embodiment is particularly helpful to achieve higher utilizations of alpha-acids in the case of brew kettle additions of powdered hops or hop pellets.

In a preferred embodiment of the present invention, the modified milled hops, the modified powdered hops or the modified hop pellets, in which the hop acids have been (partially) transformed into the corresponding quaternary ammonium salts by blending the milled hops, the powdered hops or the hop pellets with quaternary ammonium compounds, are added to an (acidic) aqueous medium.

In a preferred embodiment of the present invention, the hop acids containing matter is an isomerized hop extract (containing a.o. iso-alpha-acids and beta-acids), an extract enriched in iso-alpha-acids, a purified iso-alpha-acid extract, or an iso-alpha-acid concentrate; with the iso-alpha-acids predominantly present in their free acid form. These iso-alpha-acids are, in the ex-situ application mode, (partially) converted to the corresponding quaternary ammonium salts upon mixing with quaternary ammonium compounds (or a mixture thereof), prior to their addition to the (acidic) aqueous medium. Optionally, the addition of the quaternary ammonium salts of the iso-alpha-acids to the (acidic) aqueous medium (e.g. the wort medium) may be preceded by an addition to another (less acidic) aqueous medium. This embodiment is especially useful to achieve higher utilizations of iso-alpha-acids in the case of brew kettle additions (but also for post-fermentation additions) of isomerized hop extracts and also particularly useful to produce aqueous solutions of iso-alpha-acids (5 weight % iso-alpha-acids and higher), with (additional) water addition after the quaternary ammonium salt formation.

In a preferred embodiment of the present invention, the modified isomerized hop extract or the modified iso-alpha-acid concentrate, in which the hop acids (in particular the iso-alpha-acids) have (partially) been transformed into the corresponding quaternary ammonium salts by mixing the isomerized hop extract or iso-alpha-acid concentrate with quaternary ammonium compounds, is added to an (acidic) aqueous medium.

In a preferred embodiment of the present invention, the hop acids containing matter are extracts or concentrates containing reduced alpha-acids, reduced beta-acids or reduced iso-alpha-acids (or mixtures thereof); with the reduced hop acids predominantly present in their free acid form. The reduced hop acids, respectively the reduced alpha-acids, reduced beta-acids and reduced iso-alpha-acids are, in the ex-situ application mode, (partially) converted to quaternary ammonium salts upon mixing with quaternary ammonium compounds prior to their addition to the aqueous medium. Optionally, the addition of the quaternary ammonium salts of the reduced hop acids to the (acidic) aqueous medium (e.g. the wort medium) may be preceded by an addition to another (less acidic) aqueous medium. This embodiment is especially useful to achieve higher utilizations of reduced iso-alpha-acids in the case of brew kettle additions as well as post-fermentation additions, and also particularly useful to produce (concentrated) aqueous solutions of reduced iso-alpha-acids, with (additional) water addition after the quaternary ammonium salt formation.

In a preferred embodiment of the present invention, the hop acids containing matter is a regular hop extract (containing i.α. alpha-acids and beta-acids), an extract enriched in alpha-acids, or a purified alpha-acid extract. The alpha-acids are, in the ex-situ application mode, (partially) transformed, upon mixing with quaternary ammonium compounds (or mixtures thereof), to the corresponding quaternary ammonium humulate salts, combined with a (partial) isomerization to the corresponding quaternary ammonium salts of the iso-alpha-acids (or quaternary ammonium isohumulate salts), prior to their addition to the (acidic) aqueous medium or to another (more acidic) aqueous medium. This embodiment is especially useful to achieve higher utilizations of alpha-acids in the case of brew kettle additions of hop extracts and also particularly useful to produce aqueous solutions of iso-alpha-acids, with water addition after the quaternary ammonium salt formation.

In a preferred embodiment of the present invention, the modified hop extract, in which the present alpha-acids have been (partially) transformed into quaternary ammonium humulate salts and (partially) isomerized into the corresponding quaternary ammonium isohumulate salts, by mixing the hop extract with quaternary ammonium compounds, is added to an (acidic) aqueous medium.

In a preferred embodiment of the present invention, the hop acids containing matter are milled hops, powdered hops or hop pellets (containing a.o. alpha-acids and beta-acids). The alpha-acids in the milled hops, powdered hops or hop pellets are, in the ex-situ application mode, (partially) transformed, upon blending with quaternary ammonium compounds (or a mixture thereof), into quaternary ammonium humulate salts, combined with a (partial) isomerization to the corresponding quaternary ammonium isohumulate salts, prior to their addition to the (acidic) aqueous medium or to another (more acidic) aqueous medium. This embodiment is particularly helpful to achieve higher higher alpha-acid utilizations, in the case of brew kettle additions of milled hops, powdered hops or hop pellets.

In a preferred embodiment of the present invention, the modified milled hops, the modified powdered hops or the modified hop pellets, in which the alpha-acids have been (partially) transformed into quaternary ammonium humulate salts and (partially) isomerized into the corresponding quaternary ammonium isohumulate salts, by blending the milled hops, the powdered hops or the hop pellets with quaternary ammonium compounds, are added to an (acidic) aqueous medium.

In a preferred embodiment of the present invention, the hop acids containing matter is a regular hop extract (containing alpha-acids and beta-acids among other hop compounds), an extract enriched in alpha-acids, a purified alpha-acid extract, an alpha-acid concentrate, an extract enriched in beta-acids, a purified beta-acid extract, or a beta-acid concentrate; with the alpha-acids and beta-acids predominantly present in their free acid form. The hop acids present in this hop extract are, in the in-situ application mode, (partially) transformed into quaternary ammonium salts upon addition of quaternary ammonium compounds to the aqueous medium, and extracted into this aqueous medium. This can be combined with a (partial) isomerization of the eventually present alpha-acids (in the form of quaternary ammonium humulate salts) to the corresponding quaternary ammonium isohumulate salts. This embodiment is in particular useful for pre-extraction of alpha-acids (and beta-acids), from a hop extract into an aqueous medium, and optional (partial) alpha-acid pre-isomerization in that aqueous medium (volume of e.g. <50 L, at a pH of e.g. >5.5 or >7, with an added hop acid content in the range of 5-10 weight % for example), prior to the addition to the more acidic wort medium in the brew kettle (500 hL volume). This embodiment is also useful to produce aqueous solutions of alpha-acids, aqueous solutions of iso-alpha-acids and aqueous solutions of beta-acids.

In a preferred embodiment of the present invention, the hop acids containing matter are milled hops, powdered hops or hop pellets (containing a.o. alpha-acids and beta-acids; predominantly in their free acid form). The hop acids in the milled hops, powdered hops or hop pellets are, in the in-situ application mode, (partially) transformed into the corresponding quaternary ammonium salts upon addition of quaternary ammonium compounds to the aqueous medium, and extracted into the aqueous medium. This can be combined with a (partial) isomerization of the possibly present alpha-acids to the corresponding quaternary ammonium isohumulate salts. This embodiment is particularly helpful for pre-extraction of alpha-acids (and beta-acids) from milled hops, powdered hops or hop pellets into an aqueous medium, which can be combined with (partial) alpha-acid pre-isomerization in that aqueous medium, for example at a neutral pH, prior to the addition to the more acidic wort medium in the brew kettle (pH 5).

In a preferred embodiment of the present invention, the hop acids containing matter is an isomerized hop extract (containing among other hop compounds a large fraction of iso-alpha-acids and beta-acids with a small fraction of alpha-acids), an extract enriched in iso-alpha-acids, a purified iso-alpha-acid extract, or an iso-alpha-acid concentrate; with the iso-alpha-acids mostly in their free acid form. The iso-alpha-acids present in this hop extract are, in the in-situ application mode, (partially) transformed into the corresponding quaternary ammonium salts upon addition of quaternary ammonium compounds to the aqueous medium, and are extracted into the aqueous medium. This embodiment is especially useful for pre-extraction of iso-alpha-acids from an isomerized hop extract into an aqueous medium (typically about 50 L volume) at e.g. a neutral pH, prior to the addition to the more acidic wort medium in the brew kettle (500 hL volume). This embodiment is also useful to produce aqueous solutions of iso-alpha-acids.

In a preferred embodiment of the present invention, the aforementioned aqueous solution of iso-alpha-acids, in which the iso-alpha-acids are present as quaternary ammonium isohumulate salts, is added to an (acidic) aqueous medium, for example as a brew kettle addition or a post-fermentation addition.

In a preferred embodiment of the present invention, the hop acids containing matter are extracts or concentrates containing reduced alpha-acids, reduced beta-acids or reduced iso-alpha-acids (or mixtures thereof); with the reduced hop acids mostly present in their free acid form. The reduced hop acids are, in the in-situ application mode, (partially) transformed into the corresponding quaternary ammonium salts upon addition of quaternary ammonium compounds to the aqueous medium, and are extracted into the aqueous medium. This embodiment is particularly useful to produce (concentrated) aqueous solutions of such reduced hop acids (5 weight % of reduced hop acids and higher).

In a preferred embodiment of the present invention, the aforementioned aqueous solution of reduced hop acids, in which reduced hop acids are present as quaternary ammonium salts, is added to an (acidic) aqueous medium, for example as a brew kettle addition or a post-fermentation addition.

The following Examples illustrate the invention:

### Example 1

All transformation and addition experiments in this Example were performed in triplicate for statistical reliability. The alpha-acid and beta-acid content of the hop acids containing matter, in this Example a regular hop extract, were respectively 42 weight % and 26 weight %.

To 10 g of this regular hop extract (containing 4.2 g of alpha-acids and 2.6 g of beta-acids) was added 2.2 g of choline hydroxide (same molar amount as the molar quantity of alpha-acids and beta-acids) in a vessel. After insertion of a magnetic stirrer, the vessel was closed, flushed with nitrogen gas and subsequently pressurized with 0.2 MPa nitrogen gas. Next, this mixture was stirred and heated to 333 K for 15 min. A modified hop extract containing choline salts of alpha-acids (or choline humulate salts), with an alpha-acid content of 34 weight %, was obtained.

Next, 0.66 g respectively 1.32 g of this modified hop extract (containing choline humulate salts) were added to two separate 5 L boiling lager wort volumes (start pH 5.4), which corresponds to alpha-acid additions of respectively 45 mg/L and 90 mg/L. In both cases, a boiling time after the addition of the modified hop extract of 60 min was applied. After the wort boiling, the wort volumes were cooled to 283 K and in each case a 100 mL volume was taken, and held in a closed brown-glass vessel at 298 K for 180 min, prior to HPLC analysis.

As a control experiment to evaluate the addition of alpha-acids in the free acid form as in a regular hop extract, 0.54 g and 1.07 g of the non-modified regular hop extract were also added to two separate 5 L boiling lager wort volumes (start pH 5.4), which again corresponds to alpha-acid additions of respectively 45 mg/L and 90 mg/L. The wort boiling and sample taking procedure were the same as for the modified hop extract.

The HPLC analyses were performed with an HPLC device. The UV detection was performed at 256 nm for the iso-alpha-acids.

The 45 mg/L alpha-acid addition using the modified hop extract resulted in an iso-alpha-acid concentration in the cooled wort of 26 mg/L, while the addition of 90 mg/L alpha-acids in the form of choline salts led to a 47 mg/L iso-alpha-acid concentration. This corresponds for the modified hop extract to alpha-acid utilizations (evaluated at the cooled wort stage) of respectively 58% and 52%.

For the 45 mg/L alpha-acid addition using the regular hop extract an iso-alpha-acid concentration in the cooled wort of 14 mg/L was obtained, and 23 mg/L of iso-alpha-acids for the 90 mg/L alpha-acid addition. This corresponds for the non-modified hop extract to alpha-acid utilizations of respectively 31% and 26%.

### Example 2

All transformation and addition experiments in this Example were performed in triplicate for statistical reliability. The alpha-acid and beta-acid content of the hop acids containing matter, in this Example powdered hops (obtained by cooled milling of dried hop cones), were respectively 15 weight % and 9 weight %.

To 10 g of powdered hops (containing 1.5 g of alpha-acids and 0.9 g of beta-acids) was added 1.0 g of choline bicarbonate (same molar amount as the molar quantity of alpha-acids and beta-acids), added as an aqueous 80 weight % choline bicarbonate solution, in a vessel. After thorough mechanical blending, the vessel was closed, flushed with nitrogen gas and subsequently pressurized with 0.2 MPa nitrogen gas. Next, these blends were heated to 333 K for 15 min. A modified hop powder containing choline salts of alpha-acids, with an alpha-acid content of about 13 weight %, was obtained.

Next, 1.69 g respectively 3.38 g of modified powdered hops (containing choline humulate salts) were added to two separate 5 L boiling lager wort volumes (start pH 5.4), which corresponds to alpha-acid additions of respectively 45 mg/L and 90 mg/L. In both cases, a boiling time after the addition of modified powdered hops of 60 min was applied. After the wort boiling, the wort volumes were cooled to 283 K and in each case a 100 mL volume was taken, and held in a closed brown-glass vessel at 298 K for 180 min, prior to HPLC analysis.

As a control experiment to evaluate the addition of alpha-acids in the free acid form as in regular powdered hops, 1.50 g and 3.00 g of non-modified powdered hops were also added to two separate 5 L boiling lager wort volumes (start pH 5.4), which again corresponds to alpha-acid additions of respectively 45 mg/L and 90 mg/L. The wort boiling and sample taking procedure were the same as for the modified powdered hops.

The sample analyses were performed as described in Example 1.

The 45 mg/L alpha-acid addition using the modified powdered hops (containing choline humulate salts) led to an iso-alpha-acid concentration in the cooled wort of 25 mg/L, and the addition of 90 mg/L alpha-acids in the form of choline salts resulted in a 45 mg/L iso-alpha-acid concentration. This corresponds for the modified powdered hops to alpha-acid utilizations (evaluated at the cooled wort stage) of respectively 56% and 50%.

For the 45 mg/L alpha-acid addition using regular powdered hops an iso-alpha-acid concentration in the cooled wort of 14 mg/L was obtained, and 22 mg/L of iso-alpha-acids for the 90 mg/L alpha-acid addition. This corresponds for the non-modified powdered hops to alpha-acid utilizations of respectively 31% and 24%.

### Example 3

All transformation and addition experiments in this Example were performed in triplicate for statistical reliability. The iso-alpha-acid and beta-acid content of the hop acids containing matter, in this Example an isomerized hop extract, were respectively 47 weight % and 16 weight %.

To 10 g of this isomerized hop extract (containing 4.7 g of iso-alpha-acids and 1.6 g of beta-acids) was added 2.0 g of choline hydroxide (same molar amount as the molar quantity of iso-alpha-acids and beta-acids) in a vessel. After insertion of a magnetic stirrer, the vessel was closed, flushed with nitrogen gas and subsequently pressurized with 0.2 MPa nitrogen gas. Next, this mixture was stirred and heated to 333 K for 15 min. A modified isomerized hop extract containing choline isohumulate salts, with an iso-alpha-acid content of 39 weight %, was obtained.

Next, 0.58 g respectively 1.15 g of this modified isomerized hop extract were added to two separate 5 L boiling lager wort volumes (start pH 5.4), which corresponds to iso-alpha-acid additions of respectively 45 mg/L and 90 mg/L. In both cases, a boiling time after the addition of the modified isomerized hop extract of 15 min was applied. After the wort boiling, the wort volumes were cooled to 283 K and in each case a 100 mL volume was taken, and held in a closed brown-glass vessel at 298 K for 180 min, prior to HPLC analysis.

As a control experiment to evaluate the addition of iso-alpha-acids in the free acid form, 0.48 g and 0.96 g of non-modified isomerized hop extract were also added to two separate 5 L boiling lager wort volumes (start pH 5.4), which again corresponds to iso-alpha-acid additions of respectively 45 mg/L and 90 mg/L. The wort boiling and sample taking procedure were the same as for the modified isomerized hop extract.

The sample analyses were performed as described in Example 1.

The 45 mg/L iso-alpha-acid addition using the modified isomerized hop extract (containing choline isohumulate salts) resulted in an iso-alpha-acid concentration in the cooled wort of 42 mg/L, while the addition of 90 mg/L iso-alpha-acids in the form of choline isohumulate salts led to a 82 mg/L iso-alpha-acid concentration. This corresponds for the modified isomerized hop extract to iso-alpha-acid utilizations (evaluated at the cooled wort stage) of respectively 93% and 91%.

For the 45 mg/L iso-alpha-acid addition using the non-modified isomerized hop extract an iso-alpha-acid concentration in the cooled wort of 22 mg/L was obtained, and 34 mg/L of iso-alpha-acids for the 90 mg/L iso-alpha-acid addition. This corresponds for the non-modified isomerized hop extract to iso-alpha-acid utilizations of respectively 49% and 38%.

### Example 4

All transformation and addition experiments in this Example were performed in triplicate for statistical reliability. The hexahydro-iso-alpha-acid content of the hop acids containing matter, in this Example a hexahydro-iso-alpha-acid concentrate, was 90 weight %.

To 10 g of this hexahydro-iso-alpha-acid concentrate (containing 9.0 g of hexahydro-iso-alpha-acids) was added 3.0 g of choline hydroxide (same molar amount as the molar quantity of hexahydro-iso-alpha-acids) in a vessel. After insertion of a magnetic stirrer, the vessel was closed, flushed with nitrogen gas and subsequently pressurized with 0.2 MPa nitrogen gas. Next, this mixture was stirred and heated to 333 K for 15 min. A modified hexahydro-iso-alpha-acid concentrate containing choline salts of hexahydro-iso-alpha-acids (or choline hexahydro-isohumulate salts), with a hexahydro-iso-alpha-acid content of 69 weight %, was obtained.

Next, 0.33 g respectively 0.65 g of this modified hexahydro-iso-alpha-acid concentrate were added to two separate 5 L boiling lager wort volumes (start pH 5.4), which corresponds to hexahydro-iso-alpha-acid additions of respectively 45 mg/L and 90 mg/L. In both cases, a boiling time after the addition of the modified hexahydro-iso-alpha-acid concentrate of 15 min was applied. After the wort boiling, the wort volumes were cooled to 283 K and in each case a 100 mL volume was taken, and held in a closed brown-glass vessel at 298 K for 180 min, prior to HPLC analysis.

As a control experiment to evaluate the addition of hexahydro-iso-alpha-acids in the free acid form as in the non-modified hexahydro-iso-alpha-acid concentrate, 0.25 g and 0.50 g of the hexahydro-iso-alpha-acid concentrate were also added to two separate 5 L boiling lager wort volumes (start pH 5.4), which again corresponds to hexahydro-iso-alpha-acid additions of respectively 45 mg/L and 90 mg/L. The wort boiling and sample taking procedure were the same as for the modified hexahydro-iso-alpha-acid concentrate.

The sample analyses were performed as described in Example 1, with UV detection of the hexahydro-iso-alpha-acids also at 256 nm.

The 45 mg/L hexahydro-iso-alpha-acid addition using the modified hexahydro-iso-alpha-acid concentrate resulted in a hexahydro-iso-alpha-acid concentration in the cooled wort of 39 mg/L, while the addition of 90 mg/L hexahydro-iso-alpha-acids in the form of choline salts led to a 77 mg/L hexahydro-iso-alpha-acid concentration. This corresponds for the modified hexahydro-iso-alpha-acid concentrate to hexahydro-iso-alpha-acid utilizations (evaluated at the cooled wort stage) of respectively 87% and 85%.

For the 45 mg/L hexahydro-iso-alpha-acid addition using the non-modified hexahydro-iso-alpha-acid concentrate a hexahydro-iso-alpha-acid concentration in the cooled wort of 18 mg/L was obtained, and 34 mg/L of hexahydro-iso-alpha-acids for the 90 mg/L hexahydro-iso-alpha-acid addition. This corresponds for the non-modified hexahydro-iso-alpha-acid concentrate to hexahydro-iso-alpha-acid utilizations of respectively 40% and 29%.

### Example 5

All transformation and addition experiments in this Example were performed in triplicate for statistical reliability. The iso-alpha-acid content of the hop acids containing matter, in this Example an iso-alpha-acid concentrate, was 95 weight %.

To 10 g of this iso-alpha-acid concentrate (containing 9.5 g of iso-alpha-acids) in 176 mL purified water in a vessel was added 4.0 g of choline hydroxide (1.25 molar excess of choline hydroxide added with respect to the molar quantity of iso-alpha-acids). After insertion of a magnetic stirrer, the vessel was closed, flushed with nitrogen gas and subsequently pressurized with 0.2 MPa nitrogen gas. Next, this mixture was stirred and heated to 333 K for 15 min. An aqueous solution containing choline salts of iso-alpha-acids, or choline isohumulate salts, with an iso-alpha-acid content of 5 weight %, was obtained.

To 10 g of this iso-alpha-acid concentrate (containing 9.5 g of iso-alpha-acids) in 174 mL purified water in a vessel was added 5.9 g of tetramethylammonium hydroxide pentahydrate (1.25 molar excess of tetramethylammonium hydroxide added with respect to the molar quantity of iso-alpha-acids). After insertion of a magnetic stirrer, the vessel was closed, flushed with nitrogen gas and subsequently pressurized with 0.2 MPa nitrogen gas. Next, this mixture was stirred and heated to 333 K for 15 min. An aqueous solution containing tetramethylammonium salts of iso-alpha-acids, or tetramethylammonium isohumulate salts, with an iso-alpha-acid content of 5 weight %, was obtained.

2.0 g and 4.0 g of the 5 weight % aqueous choline isohumulate solution were added to two separate 5 L boiling lager wort volumes (pH 5.4), which corresponds to iso-alpha-acid additions of respectively 20 mg/L and 40 mg/L. In both cases, a boiling time after the addition of the aqueous choline isohumulate solution of 15 min was applied. After the wort boiling, the wort volumes were cooled to 283 K and in each case a 100 mL volume was taken, and held in a closed brown-glass vessel at 298 K for 180 min, prior to HPLC analysis.

Next, 2.0 g and 4.0 g of the 5 weight % aqueous choline isohumulate solution were added to two separate 5 L unhopped finished lager beer volumes (pH 4.3, at 283 K, gently agitated), which corresponds to iso-alpha-acid additions (of the post-fermentation type) of respectively 20 mg/L and 40 mg/L. In both cases, a mixing time after the addition of the choline isohumulates of 15 min was applied. Next, a 100 mL volume was taken in both cases, and held in a closed brown-glass vessel at 283 K for 180 min, prior to HPLC analysis.

The same addition (to the unhopped finished lager beer) and sample taking procedure was applied for the aqueous tetramethylammonium isohumulate solution.

The sample analyses were performed as described in Example 1.

The 20 mg/L iso-alpha-acid addition to the boiling lager wort using the aqueous choline isohumulate solution resulted in an iso-alpha-acid concentration in the cooled wort of 19 mg/L, while the addition of 40 mg/L iso-alpha-acids in the form of choline salts led to a 37 mg/L iso-alpha-acid concentration. This corresponds for the aqueous choline isohumulate solution to iso-alpha-acid utilizations (evaluated at the cooled wort stage) of respectively 94% and 92%.

The 20 mg/L iso-alpha-acid addition to the unhopped finished lager beer (post-fermentation) using the aqueous choline isohumulate solution resulted in an iso-alpha-acid concentration of 18 mg/L, while the addition of 40 mg/L iso-alpha-acids in the form of choline salts led to a 35 mg/L iso-alpha-acid concentration. This corresponds for the aqueous choline isohumulate solution to iso-alpha-acid utilizations (evaluated at the finished beer stage) of respectively 90% and 88%.

For the 20 mg/L iso-alpha-acid addition to the unhopped finished lager beer using the aqueous tetramethylammonium isohumulate solution an iso-alpha-acid concentration of 17 mg/L was obtained, and 32 mg/L of iso-alpha-acids for the 40 mg/L iso-alpha-acid addition. This corresponds for the aqueous tetramethylammonium isohumulate solution to iso-alpha-acid utilizations (evaluated at the finished beer stage) of respectively 85% and 81%.

1. A method comprising:
extracting into a first aqueous medium hop acids from a hop acids containing matter; and
dissolving said hop acids in said first aqueous medium to yield an aqueous phase;
said extracting and said dissolving comprising:
contacting (blending or mixing) said hop acids containing matter with one or more quaternary ammonium compounds, thereby forming quaternary ammonium salts of said hop acids;
wherein the hop acid content in the aqueous medium within which the quaternary ammonium salt formation occurs is at least 0.1 weight %.

2. The method according to claim 1, wherein the quaternary ammonium salts of the hop acids are formed, by contacting the hop acids containing matter with one or more quaternary ammonium compounds, prior to adding the quaternary ammonium salts of the hop acids to said first aqueous medium.

3. The method according to claim 2, wherein the quaternary ammonium salts of the hop acids are dissolved in an aqueous medium, prior to adding the quaternary ammonium salts of the hop acids to said first aqueous medium.

4. The method according to claim 1, wherein the quaternary ammonium salts of the hop acids are formed in an aqueous medium upon contacting the hop acids containing matter with one or more quaternary ammonium compounds.

5. The method according to claim 4, wherein the quaternary ammonium salts of the hop acids are formed in an aqueous medium upon contacting the hop acids containing matter with one or more quaternary ammonium compounds, prior to adding the quaternary ammonium salts of the hop acids to another aqueous medium.

6. (canceled)

7. The method according to claim 1, wherein said hop acids containing matter is selected from the group consisting of hop cones, raw hops, dried hops, baled hops, powdered hops, powdered hops containing iso-alpha-acids, hop pellets, hop pellets containing iso-alpha-acids, hop extracts, hop extracts containing alpha-acids and beta-acids, hop extracts hop oils and/or hop hard resins, purified alpha-acid extracts, alpha-acid concentrates, hop base extracts, purified beta-acid extracts, beta-acid concentrates, hop extracts containing iso-alpha-acids, isomerized hop extracts, hop extracts enriched in iso-alpha-acids, purified iso-alpha-acid extracts, iso-alpha-acid concentrates, hop extracts enriched in reduced hop acids, purified reduced hop acid extracts, reduced hop acid concentrates, and combinations thereof.

8. The method according to claim 1, wherein said quaternary ammonium compound is selected from the group consisting of carbon-containing chemical substances of the alcohol quaternary ammonium type, the carboxyl quaternary ammonium type, the ester quaternary ammonium type, the alkyl quaternary ammonium type, the aryl quaternary ammonium type, the N-alkyl pyridinium type and their (functionalized) derivatives.

9. The method according claim 1, wherein the molar ratio of quaternary ammonium compounds to hop acids is between 20:1 and 1:10.

10-14. (canceled)

15. A method for brewing beer or another brewed beverage, comprising:
adding quaternary ammonium salts of hop acids as obtained in the method of claim 1 to a wort medium.

16-28. (canceled)

29. A composition comprising:
hop acids containing matter containing quaternary ammonium salts of hop acids.

30. The composition of claim 29, wherein the quaternary ammonium salts of hop acids are as defined claim 1.

31-37. (canceled)

38. The method according to claim 15, wherein quaternary ammonium salts of hop acids are added to a wort medium or post-fermentation in the brewing process as a hop extract containing quaternary ammonium salts of hop acids or as an aqueous solution containing quaternary ammonium salts of hop acids.

39. The method according to claim 15, wherein quaternary ammonium salts of hop acids are dissolved in an aqueous medium, prior to their addition to the wort medium or prior to their post-fermentation addition in the brewing process.

40. The composition of claim 29, wherein the hop acids containing matter is selected from the group consisting of hop extracts containing quaternary ammonium salts of hop acids, hop acid concentrates containing quaternary ammonium salts of hop acids, hop pellets containing quaternary ammonium salts of hop acids, hop powders containing quaternary ammonium salts of hop acids and aqueous solutions containing quaternary ammonium salts of hop acids.

41. The method of claim 38, wherein quaternary ammonium salts of hop acids are dissolved in an aqueous medium, prior to their addition to the wort medium or prior to their post-fermentation addition in the brewing process.

42. The composition of claim 30, wherein the hop acids containing matter is selected from the group consisting of hop extracts containing quaternary ammonium salts of hop acids, hop acid concentrates containing quaternary ammonium salts of hop acids, hop pellets containing quaternary ammonium salts of hop acids, hop powders containing quaternary ammonium salts of hop acids and aqueous solutions containing quaternary ammonium salts of hop acids.
